(19) United States
(12) Patent Application Publication
(10) Pub. No.: US 2017/0153905 A1
(43) Pub. Date: Jun. 1, 2017

(54) USER QUEST-ANCHORED ACTIVE DIGITAL MEMORY ASSISTANT

(71) Applicant: MICROSOFT TECHNOLOGY LICENSING, LLC, Redmond, CA (US)

(72) Inventors: Gagan Chopra, Redmond, WA (US); Anand Sampathkumaran, Redmond, WA (US); Gunyoung Han, Bellevue, WA (US); Grace Li, Redmond, WA (US); Supratim Roy Chaudhury, Sammamish, WA (US)

(21) Appl. No.: 15/011,147

(22) Filed: Jan. 29, 2016

Related U.S. Application Data
(60) Provisional application No. 62/261,043, filed on Nov. 30, 2015.

(51) Int. Cl. G06F 9/44; G06F 3/0482; G06F 17/30

(52) U.S. Cl. CPC G06F 9/4446; G06F 17/30598; G06F 3/0482

(57) ABSTRACT

Systems, methods, and computer-readable storage media are provided for organizing information pertaining to entity quests in which a user is engaged in an easily retrievable and viewable manner. An active digital memory assistant on a user computing device may automatically detect and organize activity, taken by a particular user and centered on a single user intent, into an entity list. Information comprising a relevant entity list may be proactively surfaced to the user when the user is performing a task for which a related entity list exists. Alternatively, the user may manually invoke the active digital memory assistant (e.g., via selection of an appropriate icon or tile on the user's desktop) to show his or her entity related activity in the form of content previously extracted and actions previously taken.

### CROSS-REFERENCE TO RELATED APPLICATIONS

This application claims priority to U.S. Provisional Patent Application No. 62/261,043 entitled “Entity-Anchored Active Digital Memory Assistant,” filed Nov. 30, 2015, which is incorporated herein by reference in its entirety.

### BACKGROUND

When deciding to purchase certain types of products (e.g., electronics, automobiles, houses, travel, and the like), consumers often consider multiple products over an extended period of time before deciding to purchase. Additionally, consumers tend to revisit information about the products they are considering. This consumer behavior generally takes place not at a single location (e.g., a single consumer website, a single computing device or the like) but across multiple websites, in brick-and-mortar stores, and in apps on their smartphones. Lacking, however, is an easy tool to keep track of the products being considered, allowing consumers to compare the products across sellers and information mediums and allowing them to make the most informed purchasing decisions possible. Rather, consumers resort, for instance, to parking items in shopping carts associated with various vendor and/or consumer websites, keeping written notes on paper or digital notes on their computing devices, snapping and saving screen shots, emailing themselves information or, most likely, some combination of all these means of capturing information for later retrieval and reference.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In various embodiments, systems, methods, and computer-readable storage media are provided for organizing information pertaining to quests in which a user is engaged in an easily retrievable and viewable manner. A “quest,” as described herein, refers to a collection of related activity (via browsers, apps, brick-and-mortar locations, and the like) centered on a single user intent. Such intent may be, by way of example only, a consumer shopping quest for a product belonging to a particular product category or type (e.g., a laptop or other electronic device, a car, or a house), or a consumer shopping quest for a plurality of products of the same or varying product categories or types that are collectively centered around a user intent (e.g., multiple articles of clothing and accessories comprising an outfit, or a collection of items related to a travel instance, such as airfare, rental car, hotels, restaurants, etc.). An active digital memory assistant on a user computing device may automatically detect and organize activity, engaged in by a particular user and centered on a single user quest or intent, into an entity list. Information comprising a relevant entity list may be proactively surfaced to the user by the system when the user is performing a task for which a relevant entity list exists and/or when indicators for periodic or opportunistic surfacing are detected. Alternatively, the user may manually invoke the active digital memory assistant (e.g., via selection of an appropriate icon or tile on the user's desktop) to show his or her quest-related activity in the form of content previously extracted and/or actions previously taken. In embodiments, a single user may simultaneously be engaged in multiple related or unrelated quests. In such embodiments, the active digital memory assistant may automatically detect and organize activity for each quest separately into entity lists that are separate from the quests/entity lists associated with other quests engaged in by the user.

Embodiments hereof provide for organizing an active digital memory specific to a user and anchored by particular entity quests that are centered on identifiable user intents. Such organization saves the user time in conducting entity quests, for instance, in researching and considering products belonging to a particular product category and/or a plurality of product categories that are collectively centered on a user intent. Embodiments further provide for organizing entity (e.g., product) information across vendors (online and offline) which enables smart, more informed decision making for consumers.

### BRIEF DESCRIPTION OF THE DRAWINGS

The present invention is illustrated by way of example and not limitation in the accompanying figures in which like reference numerals indicate similar elements and in which:

FIG. 1 is a block diagram of an exemplary computing environment suitable for use in implementing embodiments of the present invention;

FIG. 2 is a schematic diagram of an exemplary workflow for triggering generation of an active digital memory assistant prompt, in accordance with embodiments of the present invention;

FIG. 3 is a schematic diagram of an exemplary workflow for initiating an active digital memory assistant from a generated prompt, in accordance with embodiments of the present invention;

FIG. 4 is an exemplary screen display illustrating an initiation indicator from an entity (product) page for an active digital memory assistant, in accordance with embodiments of the present invention;

FIG. 5 is an exemplary screen display illustrating presentation of information related to a user quest from an active digital memory assistant, in accordance with embodiments of the present invention;

FIG. 6 is an exemplary screen display illustrating presentation of a wish list for an active digital memory assistant, in accordance with embodiments of the present invention;

FIG. 7 is an exemplary screen display illustrating expanded information for one item on the wish list of the active digital memory assistant information presented in FIG. 6, in accordance with embodiments of the present invention;

FIG. 8 is an exemplary screen display illustrating a side-by-side comparison of two entities/products from the wish list of the active digital memory assistant information presented in FIG. 6, in accordance with embodiments of the present invention;

FIG. 9 is an exemplary screen display illustrating a desktop tile for initiating an active digital memory assistant, in accordance with embodiments of the present invention;

FIG. 10 is an exemplary screen display illustrating a proactive prompt to track an entity/product via an active digital memory assistant information, in accordance with embodiments of the present invention;

FIG. 11 is a schematic diagram of an exemplary workflow for comparisons of entities/products, in accordance with embodiments of the present invention;

FIG. 12 is a schematic diagram of an exemplary workflow for scraping information pertaining to entities/products, in accordance with embodiments of the present invention;

FIG. 13 is a schematic diagram of an exemplary workflow for logging user interactions related to entity quests, in accordance with embodiments of the present invention;

FIG. 14 is a schematic diagram of an exemplary workflow for collecting user browsing history for an active digital memory assistant, in accordance with embodiments of the present invention;

FIG. 15 is an exemplary screen display illustrating recommendations for related entities/products via an active digital memory assistant, in accordance with embodiments of the present invention;

FIG. 16 is a schematic diagram of an exemplary flow diagram illustrating a method for organizing information related to entity quests, in accordance with embodiments of the present invention;

FIG. 17 is a schematic diagram of another exemplary flow diagram illustrating a method for organizing information related to entity quests, in accordance with embodiments of the present invention; and

FIG. 18 is a schematic diagram of another exemplary flow diagram illustrating a method for organizing information related to entity quests, in accordance with embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-readable storage media for organizing information pertaining to quests in which a user is engaged in an easily retrievable and viewable manner. A “quest,” as described herein, refers to a collection of related activity (via browsers, apps, brick-and-mortar locations, and the like) centered on a single user intent. For instance, a quest may be a consumer shopping quest for a product belonging to a particular product category or type (e.g., a laptop or other electronic device, a car, or a house) or products of different categories, or a consumer shopping quest for a plurality of products of the same or varying product categories or types that are collectively centered around a user intent (e.g., multiple articles of clothing and accessories comprising an outfit, or a collection of items related to a travel instance, such as airfare, rental car, hotel, restaurants, etc.). Any action taken online by the user (or off-line and indicated by the user to be saved for later retrieval and reference in association with a particular quest) that is related to a particular user intent may comprise a quest.

In accordance with embodiments hereof, an active digital memory assistant running on a user computing device, may automatically detect and organize all user activity engaged in by a particular user and centered on a single user quest into an entity (e.g., product) list. In embodiments, a relevant entity list may be proactively surfaced to the user when the user is performing a task for which a related entity list exists (for instance, when the user is viewing a laptop product page and a “laptop” entity list is present in association with the active digital memory assistant) and/or when indicators for periodic or opportunistic surfacing are detected (e.g., pricing changes for an entity on the entity list, free time indicated by the user's schedule, upcoming expiration of a deal for an entity, or the like). Alternatively, the user may manually invoke the active digital memory assistant (e.g., via selection of an appropriate icon or tile on the user's desktop) to show all quest-related activity in the form of content previously extracted and/or actions previously taken. In embodiments, users may be reminded at appropriate instances to resume their quest or be informed about important updates to the quest (e.g., changes in pricing of a product they are considering).

In embodiments, a single user may simultaneously be engaged in multiple related or unrelated quests. In such embodiments, the active digital memory assistant may automatically detect and organize activity for each quest separately into entity lists that are separate from the quests/entity lists associated with other quests engaged in by the user.

By way of example, from a browser on a user computing device, product-related web pages the user visits may be automatically scanned and organized into related product lists. These product lists may include rich content and provide a short summary of the related products viewed including, by way of example only, name, price, vendor, description and ratings. The rich content may be sourced from relevant web pages and/or from one or more search engine entity repositories (e.g., the BING search engine repository). These rich lists constructed from the user's past activity, may be invoked on demand by the user and also may be proactively shown by the system at relevant contexts, for instance, when the user is visiting a web page of a related product, is performing a related web search, when an important detail (e.g., price) of the product has changed, or the like. In embodiments, the user may be able to organize these lists by various facets, such as number of previous visits, most recent visits, price, ratings, etc. The user also may be able to create a short list or wish list of a few products within the product category. In embodiments, the active digital memory assistant also may track attribute changes and new information such as price fluctuations, new consumer reviews, and news for at least a portion of the products and notify the user, either proactively or upon user request. The user also may be able to view new product recommendations, which the memory assistant constructs based on the user's activity and/or the larger population of users.

In embodiments, the active digital memory assistant may scan other applications as well (such as email, dedicated shopping applications and productivity tools) to monitor the user's activity and automatically identify and create related product lists across these surfaces. In embodiments, the memory assistant also may scan multiple computing devices associated with a user and provide a unified view of related product activity across them. Offline interactions with products in brick-and-mortar stores also may be incorporated by means of detected user location (potentially down to the level of specific stores, store aisles, products, etc. via a user's phone and/or a beacon), product scan with a camera associated with a user computing device, and/or other forms of manual input. These real world interactions may be enriched by providing the user with related entity (e.g., product) activity from their online interactions and vice versa.

Accordingly, exemplary embodiments are directed to methods for organizing information related to entity quests. Such exemplary methods may include determining that a user is engaged with information related to an entity (for instance, by viewing, reading, or otherwise interacting with the information); classifying the entity into at least one entity category; determining that there is an entity list associated with the user and with the at least one entity category (for instance, based on an examination of the user's history) indicating that the user is on quest to which the entity is related; and updating the entity list with at least a portion of the information with which the user is engaged.

Other exemplary embodiments are directed to methods (for instance, being performed by one or more computing devices including at least one processor) for organizing information related to entity quests. Such exemplary embodiments may include determining that a user is engaged with information related to a first entity; classifying the first entity into an entity category; determining that there is not an entity list associated with the user and with the entity category (indicating that there is not an existing quest related to the entity in which the user is engaged); and creating a new entity list associated with the entity category, the new entity list including the information related to the first entity.

Yet other exemplary embodiments are directed to one or more computer-readable storage media storing computer-useable instructions that, when used by one or more computing devices, cause the one or more computing devices to perform a method for organizing information related to entity quests. Such exemplary methods may include presenting an assistant initiation indicator, the assistant initiation indicator including information identifying at least one of an entity category and a user quest associated therewith; detecting selection of the assistant initiation indicator by a user; and presenting information related to a plurality of entities associated with the entity category and/or the user quest, the information comprising information with which the user has previously engaged and which is associated with the plurality of entities.

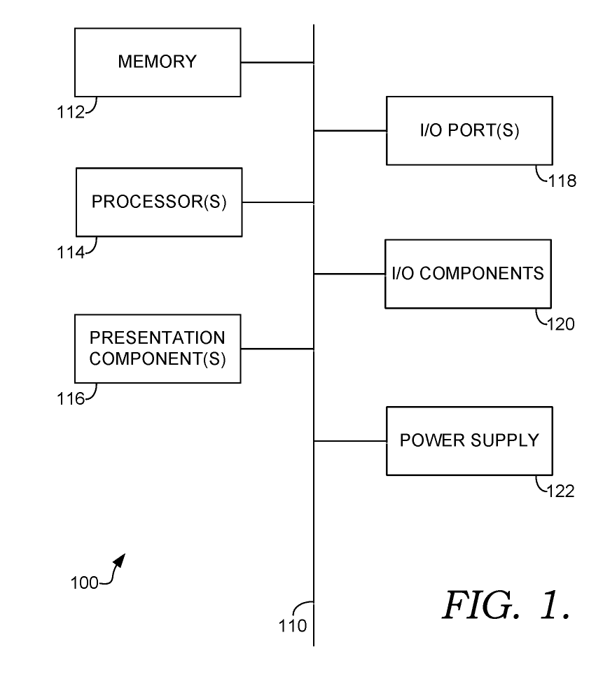

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one component nor any combination of components illustrated.

Embodiments of the invention may be described in the general context of computer code or machine-useable instructions, including computer-useable or computer-executable instructions such as program modules, being executed by a computer or other machine, such as a personal data assistant or other handheld device. Generally, program modules include routines, programs, objects, components, data structures, and the like, and/or refer to code that performs particular tasks or implements particular abstract data types. Embodiments of the invention may be practiced in a variety of system configurations, including, but not limited to, hand-held devices, consumer electronics, general-purpose computers, more specialty computing devices, and the like. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media; computer storage media excluding signals per se. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative I/O components include a microphone, joystick, game pad, satellite dish, scanner, printer, wireless device, a controller, such as a stylus, a keyboard and a mouse, a natural user interface (NUI), and the like.

A NUI processes air gestures, voice, or other physiological inputs generated by a user. These inputs may be interpreted, for instance, as words or symbols appearing in programs and/or apps, and the like presented by the computing device 100. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 100. The computing device 100 may be equipped with depth cameras, such as, stereoscopic camera systems, infrared camera systems, RGB camera systems, and combinations of these for gesture detection and recognition. Additionally, the computing device 100 may be equipped with accelerometers or gyroscopes that enable detection of motion. The output of the accelerometers or gyroscopes may be provided to the display of the computing device 100 to render immersive augmented reality or virtual reality.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices. The computer-useable instructions form an interface to allow a computer to react according to a source of input. The instructions cooperate with other code segments to initiate a variety of tasks in response to data received in conjunction with the source of the received data.

As previously set forth, embodiments of the present invention provide systems, methods, and computer-readable storage media for organizing information pertaining to entity quests in which a user is engaged in an easily retrievable and viewable manner. An active digital memory assistant on a user computing device automatically may detect and organize activity, engaged in by a particular user and centered on a single user quest or intent, into an entity list. Information comprising a relevant entity list may be proactively surfaced to the user by the system when the user is performing a task for which a relevant entity list exists and/or when indicators for periodic or opportunistic surfacing are detected. Alternatively, the user may manually invoke the active digital memory assistant (e.g., via selection of an appropriate icon or tile on the user's desktop) to show his or her quest-related activity in the form of content previously extracted and/or actions previously taken. In such embodiments, the active digital memory assistant may automatically detect and organize activity for each quest separately into entity lists that are separate from the quests/entity lists associated with other quests engaged in by the user.

For purposes of explanation herein, a description of the active digital memory assistant operating with respect to products and a user engaged in a consumer shopping quest is described. It will be understood and appreciated, however, by those having ordinary skill in the art that products are but one type of entity to which embodiments of the present invention may apply. Description of the features of the present invention in the context of one or more products is not intended to limit the scope of what may constitute an entity in accordance with embodiments of the invention. Rather, an entity may correspond to any specific, identifiable thing in a corpus of things/entities. An entity may be an abstract concept or tangible item including, by way of illustration and not limitation: a person, a place, a group, an organization, a cause, a company, an activity, an event or occurrence, and the like.

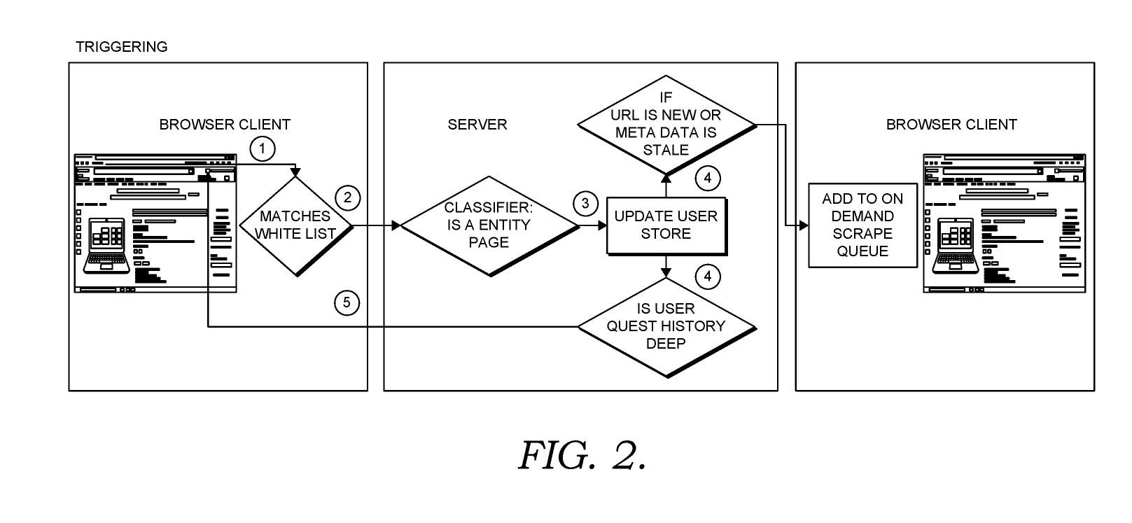

In exemplary embodiments, the active digital memory assistant may be triggered upon the user visiting a webpage at a browser on a user computing device or launching an app on a user computing device, e.g., a smartphone. An exemplary work flow illustrating this triggering functionality is illustrated in FIG. 2. Upon detecting that the user is visiting a webpage associated with a particular entity at a browser on a user computing device or that the user has launched an appropriate app on his or her computing device (e.g., smartphone), the active digital memory assistant may examine the webpage or app page and determine whether the page indicates that the user is on a consumer shopping quest for a product belonging to a particular product category or type (or, in embodiments, a consumer shopping quest for a plurality of products o the same or varying product categories or types that are collectively centered around a user quest). In making such determination, the active digital memory assistant may determine whether or not the webpage is a product page (i.e., has a dedicated product URL indicative of the product featured on the page) or if the user is otherwise viewing information about a product (e.g., a review or the like). If the user is visiting a product page or viewing information associated with a product, the active digital memory assistant may classify the product. In embodiments, the active digital memory assistant further may determine whether the product page being viewed is sourced from a white list of sources from which consumers typically garner information about products of the product category. For example, if the user, via their client browser, is visiting an AMAZON webpage featuring the “HP Stream 13.3 Inch Laptop,” the active digital memory assistant may determine that the webpage is a product page and classify it in the category “laptops.” In embodiments, the active digital memory assistant further may determine that AMAZON is a source from which consumers typically research and/or purchase laptops. By way of another example, if the user launches a WAL-MART app on their smartphone and has navigated to information about the “ACER CHROMEBOOK,” the active digital memory assistant may determine that the user is viewing information about a product and similarly may classify it in the category “laptops.” In embodiments, the active digital memory assistant further may determine that the WAL-MART app (or WAL-MART in general) is a source from which consumers typically research and/or purchase laptops.

Once it has been determined that the user is viewing information about a product belonging to a particular product category, the active digital memory assistant may determine whether the product is part of an already existing consumer shopping quest. For instance, following the above-example, the active digital memory assistant may determine if the user already is known to be on a shopping quest for a laptop. If it is determined that the user already is known to be on a shopping quest for a product of the determined product category (or for a collection of products of varying categories that collectively comprise a shopping quest), information about the user's current, memory assistant-triggering behavior may be added to the quest. Such addition may include, by way of example only, addition of the content of the webpage or app page being visited, an increase in a count of the number of times the product or page has been viewed (if the current visit is not the first), any updates in product details (e.g., price), addition of the webpage or app page being visited to an on-demand scrape queue for periodically and/or on demand product information updating, and the like.

If, however, it is determined that the user's current browsing behavior does not fit with a known shopping quest, the active digital memory assistant may determine whether the user previously has viewed information about the particular product and/or other products belonging to the product category. In making such determination, the active digital memory assistant may consider a predetermined time frame in which users typically research and consider purchases for products of the product category. For instance, determining that the user viewed information pertaining to the product category eight months ago may not indicate a shopping quest but rather a renewed and/or casual interest that does not currently rise to the level of a shopping quest. In accordance with embodiments hereof, the typical research and consideration behavior of the particular user also (or alternatively) may be considered in determining whether the user is on a quest. Any and all such variations, and any combination thereof, are contemplated to be within the scope of embodiments hereof. If it is determined that the user's current behavior is not indicative of a shopping quest, the active digital memory assistant may store the user's behavior as history (update user store) for later reference but take no further assistive action.

If, however, it is determined that the user has previously viewed information about the particular product and/or other products belonging to the product category within one or more threshold-satisfying parameters (e.g., a certain number of times information about the particular product has been viewed, a certain number of products in the product category for which product information has been viewed, a certain amount of time spent viewing the particular product or multiple products in the product category, or the like), or that the user's behavior indicates a user quest comprising a collection of products of the same or varying categories or types, a new shopping quest may be created and the behavior organized for easy retrieval and review by the user, as more fully described below.

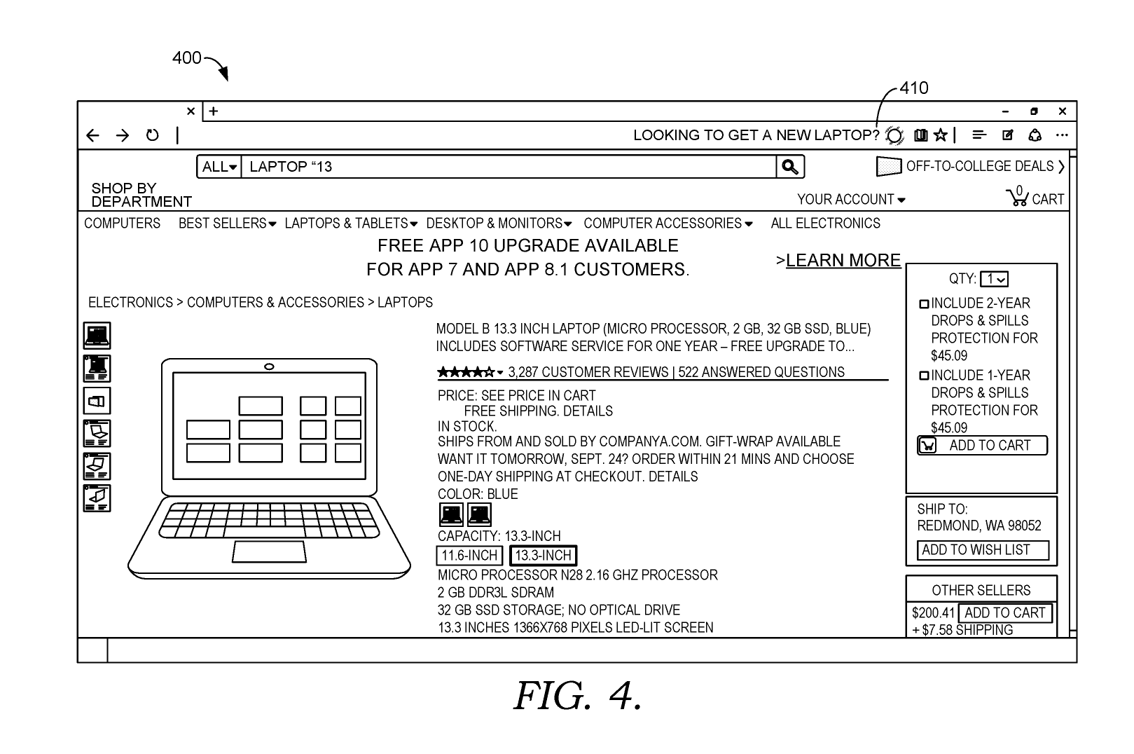

In embodiments, the “triggering” workflow entry point is the browser client detecting that the user is visiting a webpage or app page that matches the domain white list (reference numeral 1 of FIG. 2). In embodiments, if the webpage or app page matches the domain white list, a query server classifies the webpage or app page as a product page (e.g., a laptop product page) or not a product page (reference numeral 2 of FIG. 2). If the visited webpage or app page is not a product page, the active digital memory assistant may take no further assistive action and/or may store information relevant to the quest for future reference (e.g., product reviews, specification sheets, product rankings, and the like). If, however, the visited webpage or app page is a product page, the content of the page is saved to the user's laptop product page history on the server (reference numeral 3 of FIG. 2). If the URL or app page identifier is new or the metadata associated therewith is stale in the user data store, the page is added to a browser on-demand scrap queue of the active digital memory assistant for extraction of metadata and the user's history (store) is updated with the extracted metadata (reference numeral 4 of FIG. 2). If the user has a deep enough history of laptop product pages to indicate he or she is on a laptop quest, an active digital memory assistant prompt (more fully described below with reference to FIG. 4) is generated and presented in association with the webpage or app page from which the illustrated workflow was triggered (reference numeral 5 of FIG. 2).

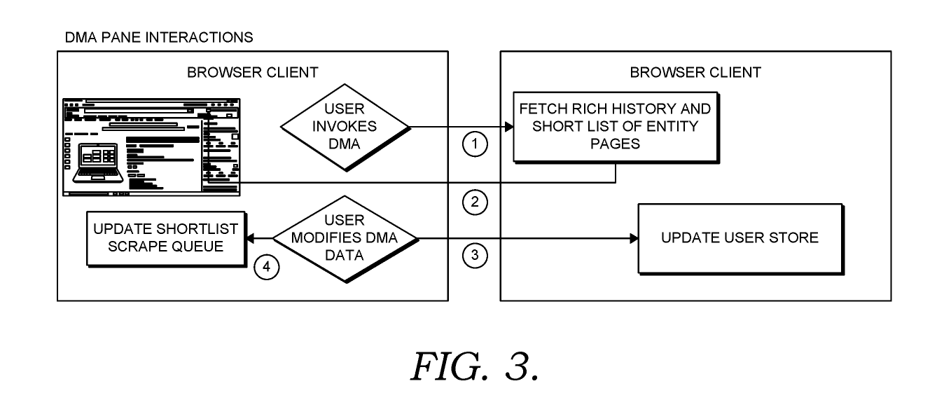

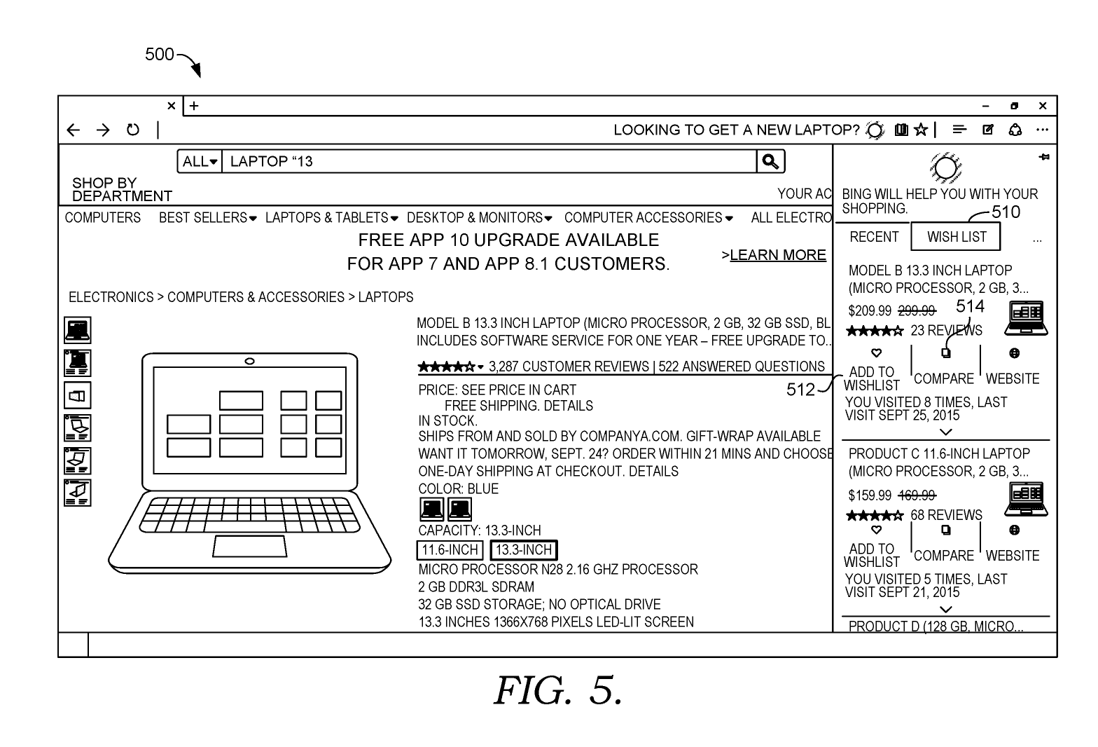

Once an active digital memory assistant prompt is associated with a particular user quest (and thus associated with and presented each time the user visits a webpage or app page determined to be relevant to the quest), the user may select the prompt and invoke the digital memory assistant. This is indicated at reference numeral 1 of FIG. 3. Once invoked, a rich history and short list of information (e.g., product pages) previously visited by the user while engaged in the present quest is retrieved and presented in a viewing pane associated with the webpage or app page from which the prompt was selected (and more fully described below with reference to FIG. 5). This is indicated at reference numeral 2 of FIG. 3. If the user modifies the quest data (e.g., by visiting webpages or app pages associated with the quest, the user store may be updated (as indicated at reference numeral 3 of FIG. 3) and a shortlist scrape queue also may be updated to ensure current and relevant metadata is scraped and such information presented in the viewing pane. This is indicated at reference numeral 4 of FIG. 3. The workflows shown in FIGS. 2 and 3 are more fully described below with reference to FIGS. 4 through 8.

Turning now to FIG. 4, illustrated is an exemplary screen display showing an initiation indicator from a product page for an active digital memory assistant, in accordance with embodiments of the present invention. As illustrated, the user is visiting a consumer website and has searched, via that site, for information pertaining to a 13 inch laptop. Upon detecting that the user is viewing a product page for the “Model B 13.3 Inch Laptop,” the memory assistant determines that the user is on a shopping quest for a laptop, as more fully described above with reference to the workflow of FIG. 2. An initiation indicator for access by the user to the information organized by the active digital memory assistant is presented, as indicated by reference numeral 410.

Upon user selection of the entry point indicator 410, the active digital memory assistant may fetch the user's organized rich history which may include, by way of example only, information extracted from product pages associated with the user's shopping quest. At least a portion of the information then may be presented in a viewing pane for viewing by the user, as shown in the exemplary screen display 500 of FIG. 5. As illustrated in FIG. 5, information pertaining to the user's shopping quest is presented in a side panel on the right-hand side of the available viewing area. It will be understood, however, that the placement of the information in relation to the viewing area is not meant to limit embodiments of the present invention in any way. In the illustrated embodiment, a graphic having similar appearance to the entry point indicator 410 is shown at the top of the viewing pane. While optional, such graphic indicates to the user the nature of the information being presented in the viewing pane.

As illustrated in FIG. 5, the active digital memory assistant presents the user with the most recently viewed information related to the current product shopping quest. Note that because the information is anchored by a user quest, shown are not the websites or product pages most recently visited by the user across all of his or her recent browsing history. Rather, shown are only those pages that pertain to products associated with the user shopping quest indicated by the page the user was visiting when the active digital memory assistant was invoked by selection of the initiation indicator 410 (FIG. 4).

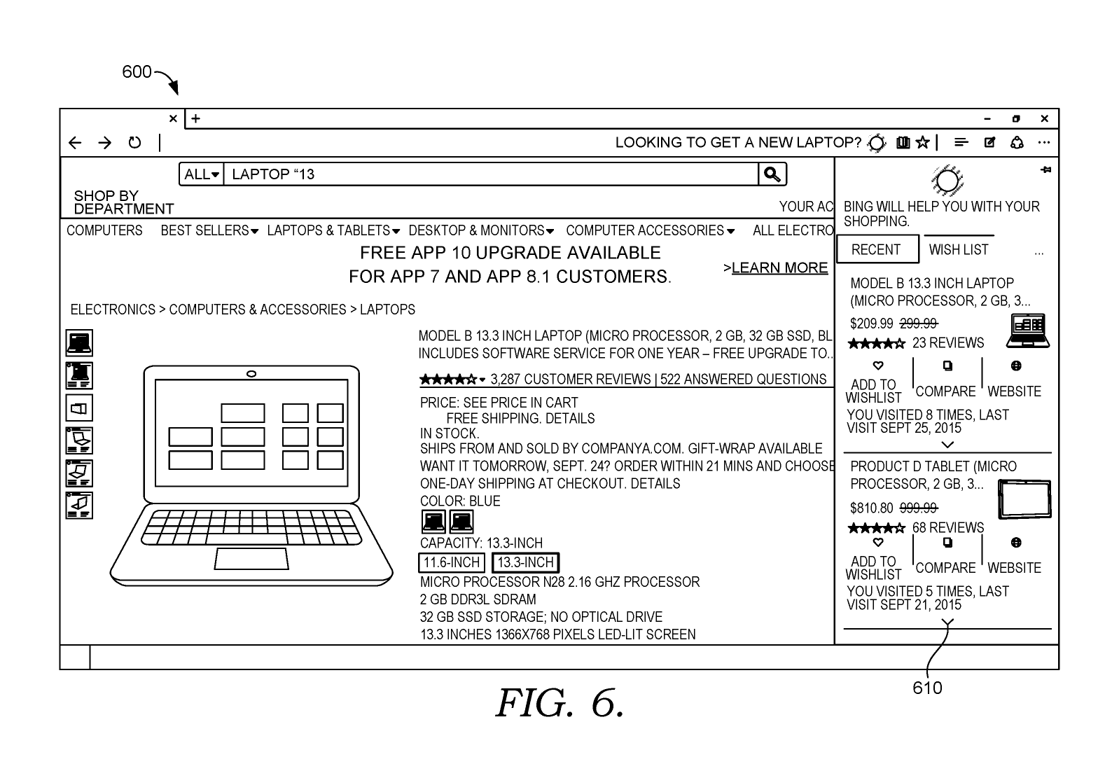

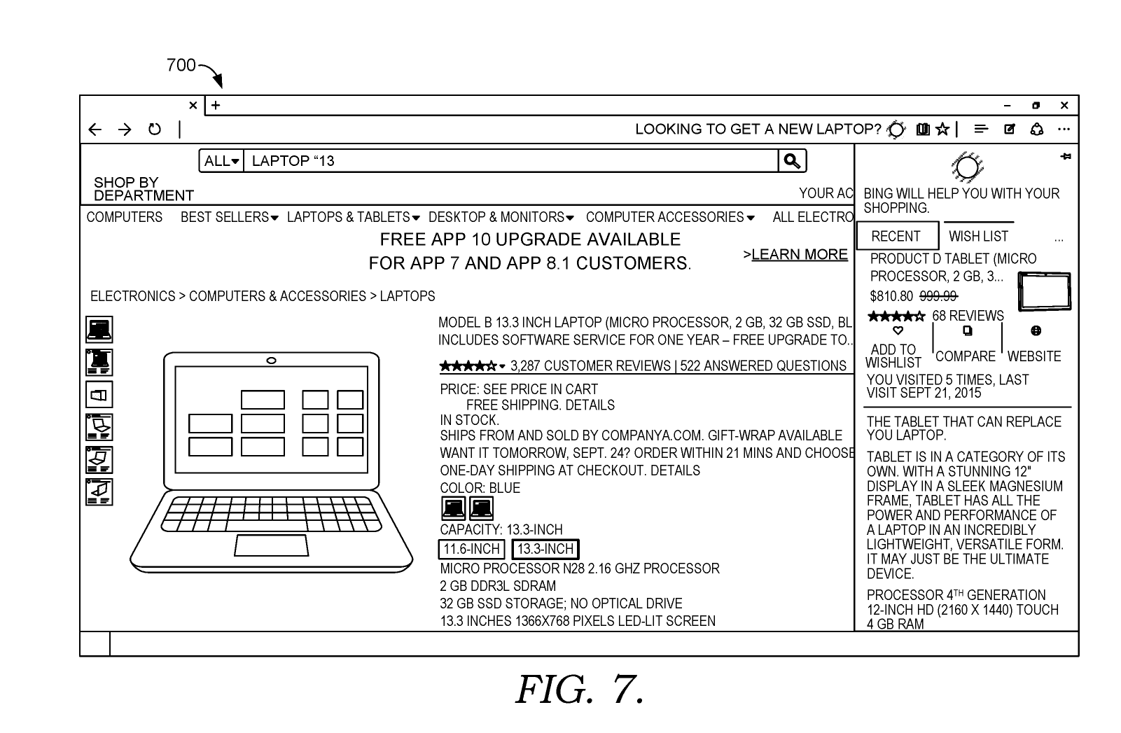

FIG. 6 illustrates an exemplary screen display 600 showing a wish list or short list of products that the user has selected to have stored by the active digital memory assistant for later access as part of his or her shopping quest. Information about these products may be viewed by selection of the “Wish list” tab 510 of FIG. 5. While the information shown is a summary or synopsis of information, in embodiments, selection of an expansion indicator may result in presentation of more detailed information about the subject product. For instance, as illustrated, selection of the expansion indicator 610 under the summarized information pertaining to the Product D Tablet, may result in presentation of more detailed information about that product, as shown in the exemplary screen display 700 of FIG. 7.

With reference back to FIG. 5, upon presentation of the user's recent activity related to the particular product shopping quest, the product page that the user was viewing when the active digital memory assistant was initiated appears at the top of the recent activity list. Also shown is an indicator of the number of times that particular product page and/or all product pages related to the product (e.g., from different websites) have previously been viewed. From this view, the user may select to add the currently viewed product page to the wish list via selection of the “add to wish list” indicator 512. The currently viewed product then appears at the top of the wish list, as shown in FIG. 6. Any activity engaged in by the user that results in an update of information associated with the recently viewed items or the wish list items for a particular shopping quest may trigger an update of the user store surrounding the product shopping quest, as well as any additional relevant updates, for instance, to the short list or wish list page scrape queue, or the like.

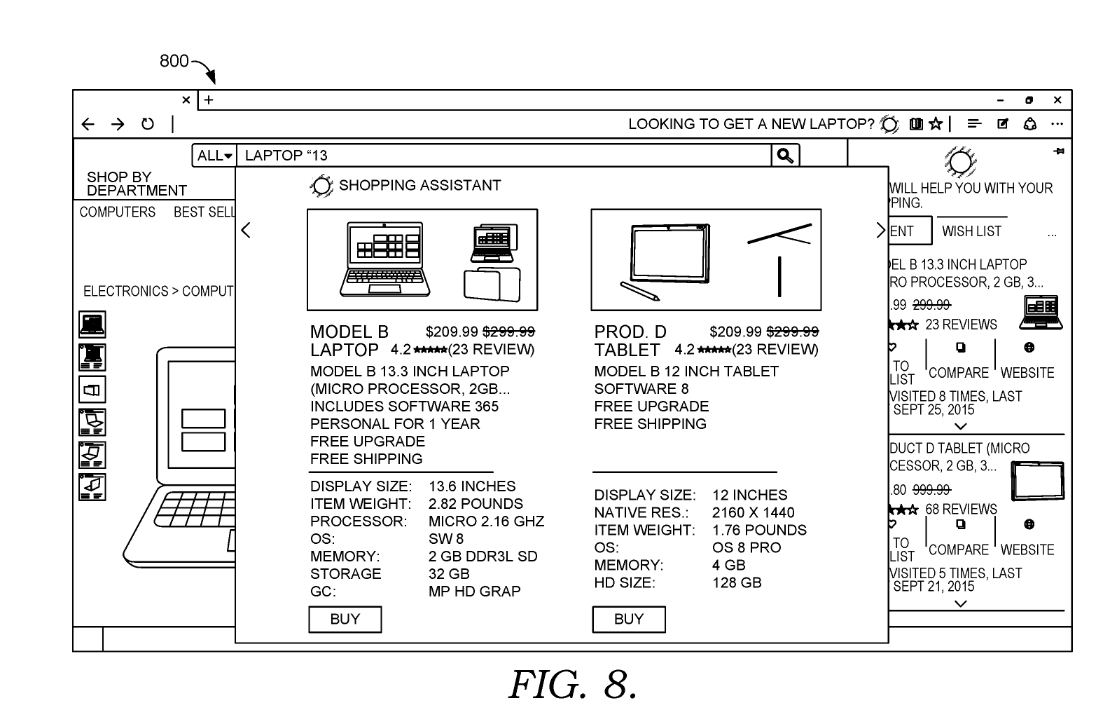

Also from the view presented in FIG. 5, the user may select to view a comparison of a product relative to another product from the wish list and/or recently viewed items by selection of the “compare” indicator 514. An exemplary screen display of two products being compared to one another is illustrated in the screen display 800 of FIG. 8. In embodiments, the active digital memory assistant may normalize the information associated with products for ease of comparison. For instance, what one laptop product may refer to as “RAM,” another may simply refer to as “memory.” In accordance with exemplary embodiments hereof, the active digital memory assistant may select one or the other of the memory titles, or a combination of the two (e.g., RAM/memory) so that side-by-side comparison becomes more meaningful to the user.

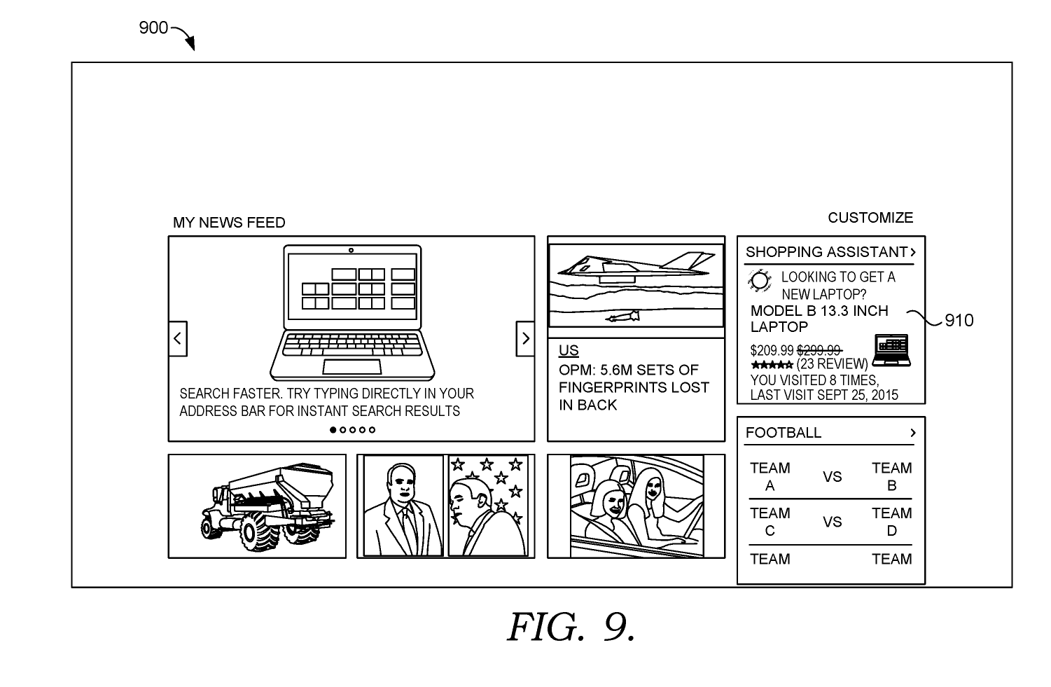

As previously stated, in addition to proactively alerting the user that a product quest assistant is available when the is viewing information pertaining to a particular product, the user may manually initiate the active digital memory assistant to show his or her entity related activity in the form of content previously extracted and actions previously taken. An exemplary screen display 900 from which an appropriate icon or tile 910 may be selected from the user's desktop to invoke the memory assistant is illustrated in FIG. 9. Once invoked, the behavior and presentation supported by the memory assistant may be similar to that discussed above with respect to the exemplary proactive alerting embodiments. In embodiments, as the user is initiating the assistant while not currently viewing information pertaining to a particular product, the presented information may take up the entire viewing area of the screen. In embodiments, the most recently viewed product information page or the product page most recently added to the wish list may be presented and the assistance information presented in a side panel as previously described. Any and all such variations, and any combination thereof, are intended to be encompassed by embodiments of the present invention.

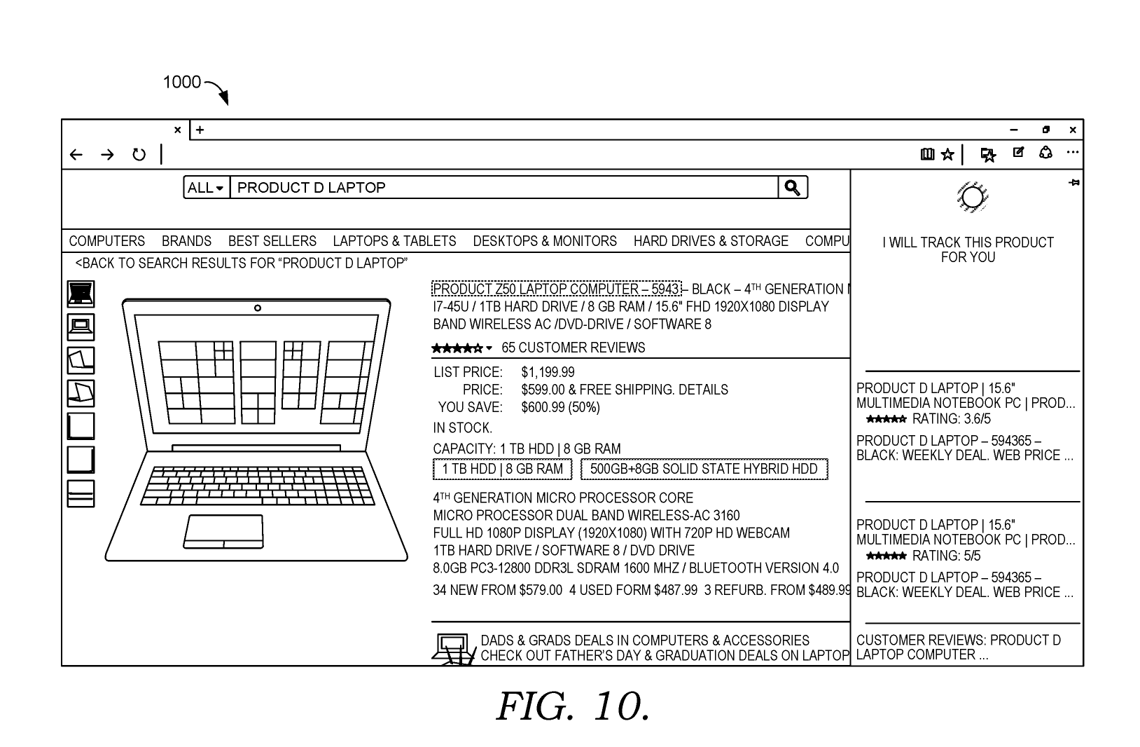

In every product quest, there is a first product view. In accordance with embodiments hereof, when a user navigates to a product page for which there is no existing product quest associated, the active digital memory assistant may proactively offer to begin a consumer shopping quest for the user. An exemplary screen display illustrating this proactive offer is illustrated in the exemplary screen display 1000 of FIG. 10.

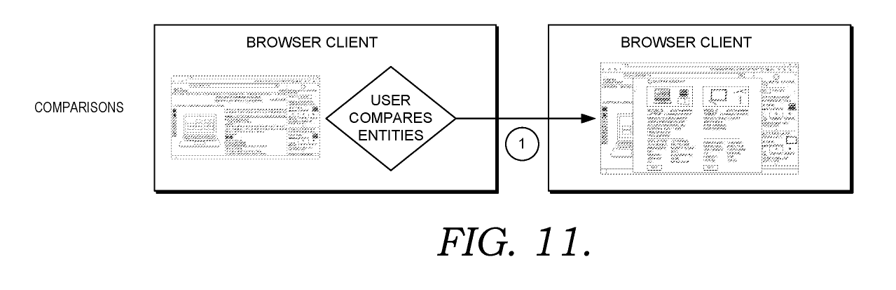

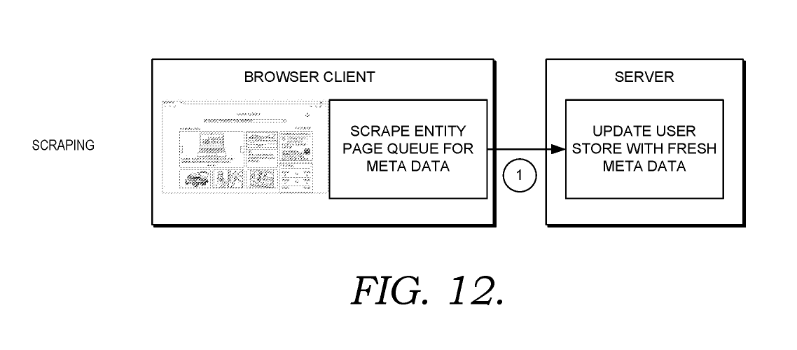

Additional exemplary work flows are illustrated in FIGS. 11-14. The flow of FIG. 11 illustrates exemplary comparison behavior, as described above with reference to FIG. 8. The flow of FIG. 12 illustrates proactive (periodic or manually initiated) scraping of product pages that are already sourced for a product list to ensure that the information associated with the product is current. Such information may be updated and stored as appropriate. The entry point to the scraping workflow is browser background scraping. In embodiments, the workflow involves two scrape queues, an on-demand queue and a periodic short list queue. Metadata is extracted from the pages in the queues and the user history and favorites are updated with the extracted metadata.

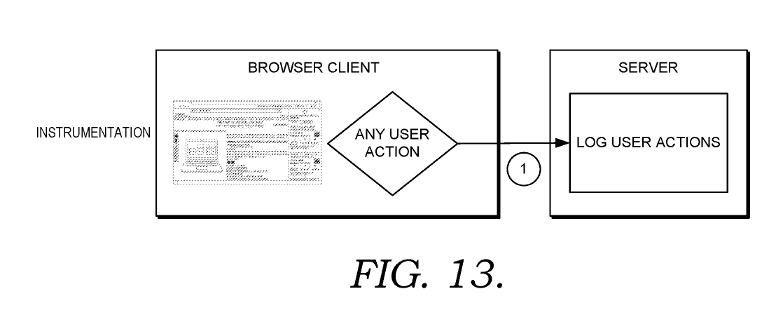

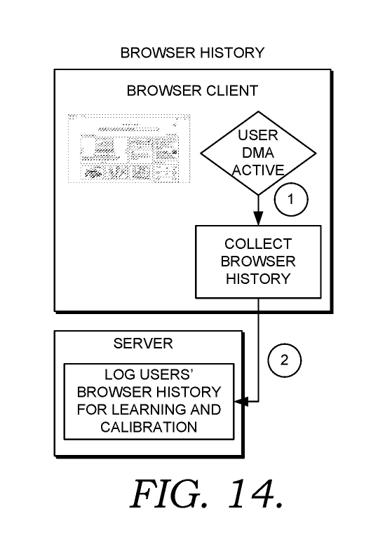

The flow of FIG. 13 illustrates that all user interactions having to do with product information (visits to product pages, and the like) may be logged for maintaining a current status of the user's consumer shopping quest. The flow of FIG. 14 illustrates logging, learning and calibration based on user's browser history on the user's client device in, for example, a persistent local storage. The entry point to the User Browse History is in the browser background for users with an active digital memory assistant. In embodiments, the workflow involves bootstrapping by sending all last N web pages from the browser history to a server, for an active memory assistant user. The browser history is logged for mining on the server with the user ID. Periodic deltas from the browser history may be sent, e.g., once a day for logging.

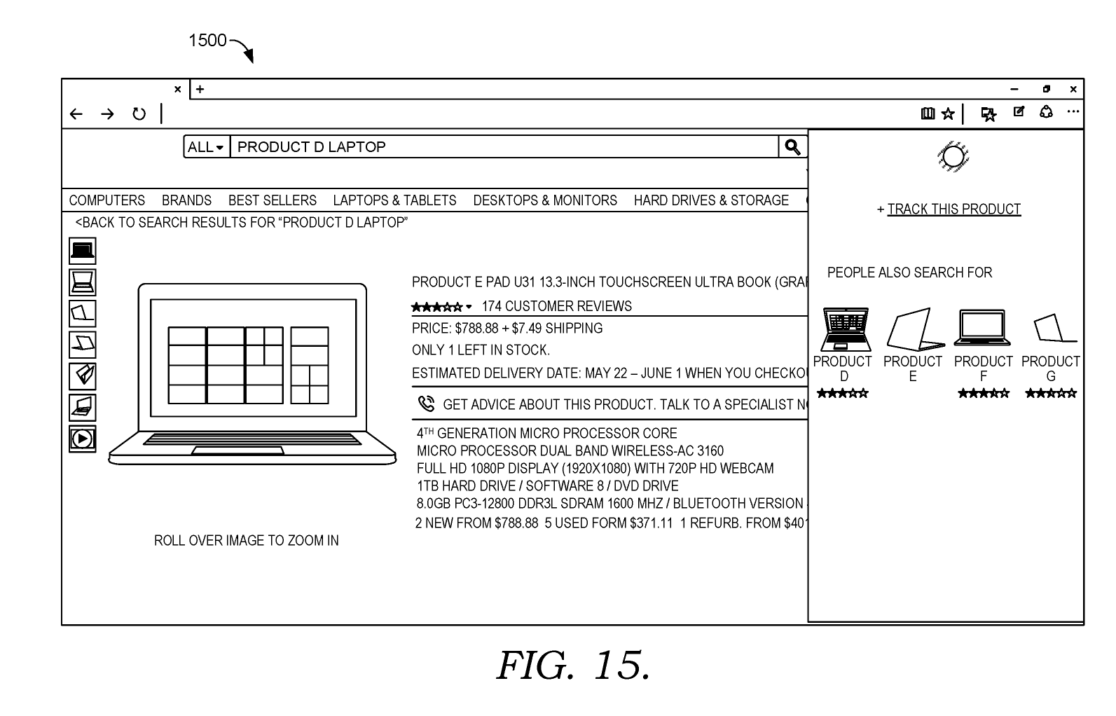

In accordance with embodiments hereof, content in a product list may be updated with recommendations based on, for instance, other consumers. This is illustrated in the exemplary screen display 1500 of FIG. 15.

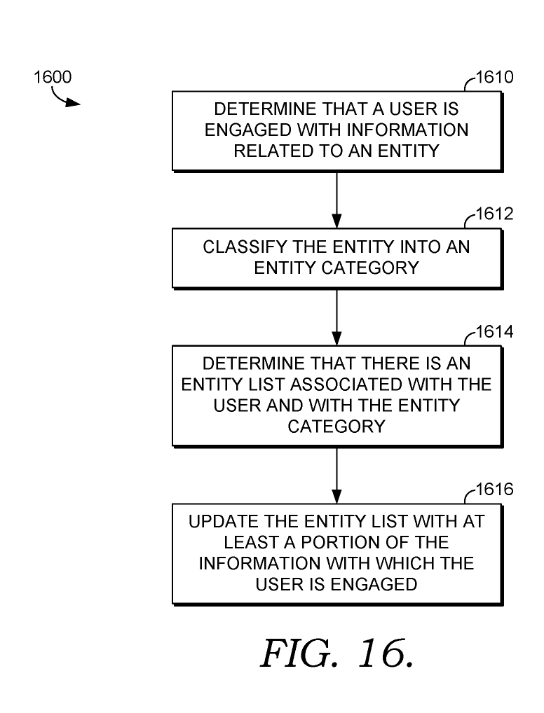

Turning now to FIG. 16, an exemplary flow diagram illustrating a method for organizing information related to entity quests, in accordance with embodiments of the present invention, is shown and designated generally as reference numeral 1600. As indicated at block 1610, it is determined that a user is engaged with information related to an entity, for instance, by determining that user is viewing, reading, or otherwise interacting with the information. As indicated at block 1612, the entity is classified into at least one entity category. As indicated at block 1614, it is determined that there is an entity list associated with the user and with the at least one entity category (for instance, based on an examination of the user's history) indicating that the user is on quest to which the entity is related. As indicated at block 1616, the entity list is updated with at least a portion of the information with which the user is engaged.

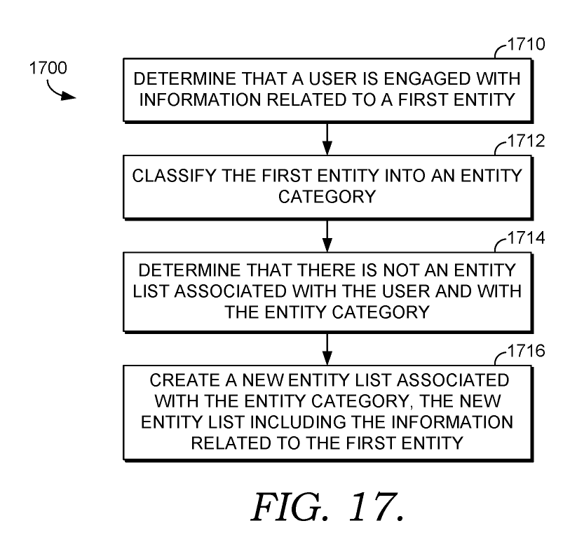

With reference to FIG. 17, another exemplary flow diagram illustrating a method for organizing information related to entity quests, in accordance with embodiments of the present invention, is shown and designated generally as reference numeral 1700. As indicated at block 1710, it is determined that a user is engaged with information related to a first entity. As indicated at block 1712, the first entity is classified into an entity category. As indicated at block 1714, it is determined that there is not an entity list associated with the user and with the entity category (indicating that there is not an existing quest related to the entity in which the user is engaged). As indicated at block 1716, a new entity list is created that is associated with the entity category, the new entity list including the information related to the first entity.

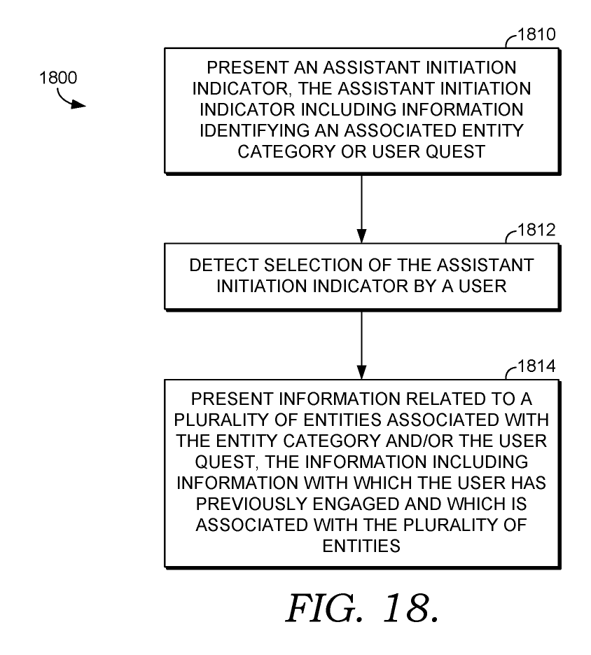

Turning to FIG. 18, yet another exemplary flow diagram illustrating a method for organizing information related to entity quests, in accordance with embodiments of the present invention, is shown and designated generally as reference numeral 1800. As indicated at block 1810, an assistant initiation indicator is presented, the assistant initiation indicator including information identifying at least one of an entity category and a user quest associated therewith. As indicated at block 1812, selection of the assistant initiation indicator by a user is detected. As indicated at block 1814, information related to a plurality of associated with the entity category and/or the user quest is presented, the information comprising information with which the user has previously engaged and which is associated with the plurality of entities.

As can be understood, embodiments of the present invention provide systems, methods, and computer-readable storage media for, among other things, organizing information pertaining to entity quests in which a user is engaged in an easily retrievable and viewable manner. The present invention has been described in relation to particular embodiments, which are intended in all respects to be illustrative rather than restrictive. Alternative embodiments will become apparent to those of ordinary skill in the art to which the present invention pertains without departing from its scope.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A method being performed by one or more computing devices including at least one processor, the method for organizing information related to entity quests and comprising:
determining that a user is engaged with information related to an entity;
classifying the entity into at least one entity category;
determining that there is an entity list associated with the user and with the at least one entity category; and
updating the entity list with at least a portion of the information with which the user is engaged.

2. The method of claim 1, further comprising:
determining that the information with which the user is engaged is associated with one of a web page and an app page; and
presenting an assistant initiation indicator in association with the one of the web page and the app page, wherein selection of the assistant initiation indicator causes at least a portion of the information associated with the entity list to be presented.

3. The method of claim 2, further comprising:
detecting selection of the assistant initiation indicator; and
presenting at least a portion of the information associated with the entity list.

4. The method of claim 3, further comprising periodically examining information associated with entities comprising the entity list to identify any changes thereto.

5. The method of claim 4, wherein presenting at least the portion of the information associated with the entity list comprises presenting an indication that at least one feature of the portion of the information associated with the entity list has changed since being viewed by the user.

6. The method of claim 2, further comprising presenting a comparison indicator, wherein selection of the comparison indicator causes at least two items comprising the entity list to be compared with one another.

7. The method of claim 2, further comprising presenting a wish list indicator, wherein selection of the wish list indicator causes one or more items comprising the entity list that have been previously tagged to be associated with a wish list to be presented.

8. The method of claim 2, further comprising presenting information associated with at least one entity that is recommended to the user based upon the entities included in the entity list.

9. A method being performed by one or more computing devices including at least one processor, the method for organizing information related to entity quests and comprising:
determining that a user is engaged with information related to a first entity;
classifying the first entity into an entity category;
determining that there is not an entity list associated with the user and with the entity category; and
creating a new entity list associated with the entity category, the new entity list including the information related to the first entity.

10. The method of claim 9, further comprising:
determining that the information with which the user is engaged is associated with one of a web page and an app page; and
presenting an assistant initiation indicator in association with the one of the web page and the app page.

11. The method of claim 10, further comprising:
detecting selection of the assistant initiation indicator; and
presenting at least a portion of the information related to the first entity.

12. The method of claim 10, further comprising:
determining that the user is engaged with information related to a second entity; and
classifying the second entity into the entity category.

13. The method of claim 12, further comprising:
detecting selection of the assistant initiation indicator; and
presenting at least a portion of the information related to the first entity and at least a portion of the information related to the second entity.

14. The method of claim 13, further comprising presenting a comparison indicator, wherein selection of the comparison indicator causes at least the portion of the information related to the first entity and at least the portion of the information related to the second entity to be compared with one another.

15. The method of claim 13, further comprising:
detecting that the user has completed or abandoned the entity quest for the at least one entity associated with the entity category; and
ceasing presentation of the assistant initiation indicator.

16. One or more computer-readable storage media storing computer-useable instructions that, when used by one or more computing devices, cause the one or more computing devices to perform a method for organizing information related to entity quests, the method comprising:
presenting an assistant initiation indicator, the assistant initiation indicator including information identifying at least one of an entity category and a user quest associated therewith;
detecting selection of the assistant initiation indicator by a user; and
presenting information related to a plurality of entities associated with the entity category or the user quest, the information comprising information with which the user has previously engaged and which is associated with the plurality of entities.

17. The one or more computer-readable storage media of claim 16, wherein presenting information related to the plurality of entities associated with the entity category comprises presenting an indication that at least one feature of the information related to the plurality of entities has changed since being previously engaged with by the user.

18. The one or more computer-readable storage media claim 17, wherein the method further comprises presenting a comparison indicator, wherein selection of the comparison indicator causes information related to at least two of the plurality of entities to be compared.

19. The one or more computer-readable storage media claim 17, wherein the method further comprises presenting a wish list indicator, wherein selection of the wish list indicator causes at least one of the plurality of entities that has been previously tagged to be associated with a wish list to be presented.

20. The one or more computer-readable storage media claim 17, wherein the method further comprises presenting information related to at least one additional entity that is recommended to the user based upon the plurality of entities.
